(19) United States
(12) Patent Application Publication
(10) Pub. No.: US 2014/0323079 A1
(43) Pub. Date: Oct. 30, 2014

(54) PERSONAL LOCATOR DEVICE

(71) Applicant: Paul S. Paolini, Lunenburg, MA (US)

(72) Inventor: Paul S. Paolini, Lunenburg, MA (US)

(21) Appl. No.: 13/874,338

(22) Filed: Apr. 30, 2013

(51) Int. Cl. G08B 25/01; H04W 4/22; H04W 4/02

(52) U.S. Cl. CPC G08B 25/016; H04W 4/02; H04W 4/22
USPC 455/404.2

(57) ABSTRACT

A personal locator device includes a housing that has a processor being coupled to a bus and a memory being coupled to the bus in the housing. The personal locator device also has a global positioning system (GPS) receiver, a GSM module and a G force sensor module. The transmitter is adapted to be controlled by the processor to provide a distress signal to a remote entity identifying the personal locator device. The mobile communication unit is adapted to be programmable to initiate communication to at least two individuals and report its location. The personal locator device is configured to raise an alert based data from on one or more of the GPS receiver, G force sensor and on activation of a SOS button provided on the housing of the personal locator device.

### CROSS REFERENCE TO RELATED PATENT APPLICATIONS

This patent applications claims priority to United States non-provisional patent application Ser. No. 12/986,516 to Paul S. Paolini entitled “A Personal Locator Device For A Child Having An Integrated Mobile Communication Device That Qualifies To Be Carried In An Educational Setting”, filed Jan. 7, 2011, which claims priority to U.S. Provisional Patent Application No. 61/295,256 to Paul S. Paolini entitled “A Personal Locator Device For A Child Having An Integrated Mobile Communication Device That Qualifies To Be Carried In An Educational Setting”, filed on Jan. 15, 2010. The above applications are herein incorporated by reference in their entirety.

### FIELD OF THE INVENTION

The present disclosure is directed to a personal locator device that can provide an emergency beacon signal reporting a position of the wearer and that includes an integrated cellular Global System for Mobile Communications (GSM) and or Global Positioning System (GPS).

### BACKGROUND OF THE RELATED ART

Child abductions occur in the United States on a level that is too frequent. Many parents will purchase their child a mobile telephone to communicate with the parents to coordinate picking up the child and for communicating with the child's nanny or guardian while at school. However, during school hours students generally will use the phone or mobile communication device to communicate with their friends in class using voice calls, e-mails, or text messages. Generally, this second use of the mobile phone may upset the progression of the class and disrupt the teachers. Students will periodically access the text messages and not pay attention in class during lectures. Also, this may result in the parent's receiving a large phone and service bill from the service provider as the students are not being monitored by the parents in school.

Therefore, many educational settings have banned the use or possession of cell phones, personal digital assistants, I-PHONE to coordinate picking up thes, I-PODS®, and BLACKBERRY® communication devices and other electronic devices. For example in New York City, Mayor Michael Bloomberg and Schools Chancellor Joel Klein have refused to drop the ban on cellular telephones notwithstanding the protests of parents. New York City, Mayor Michael Bloomberg and Schools Chancellor Joel Klein insist cell phones are a distraction and are used to cheat, take inappropriate photos in bathrooms and organize rendezvous. Cellular phones are also a frequently stolen item. However, this policy is upsetting to parents. Without a mobile communication or a tracking device, there may be a greater risk that a child can be potentially abducted or kidnapped without the mobile communication device to call for help. Therefore, there is a need in the art for a mobile communication device that can act as a GSM/GPS personal locator device and that also can be permitted to be used in an educational setting without causing disruption and that does not permit the student to call third parties, take photos, send emails or text with friends.

### SUMMARY OF THE INVENTION

According to a first aspect of the present disclosure, there is provided a personal locator device. The personal locator device includes a housing that has a processor being coupled to a bus and a memory being coupled to the bus disposed in the housing. The personal locator device also has a global positioning system comprising a receiver and a transmitter coupled to the bus. The memory comprises an identification code. The personal locator device also has a mobile communication unit being coupled to the bus and a user interface comprising at least two inputs disposed on the housing. The personal locator device also has a power source.

The transmitter is adapted to be controlled by the processor to provide a distress signal to a remote entity. The distress signal identifies the personal locator device by the identification code that a user associated with the personal locator device is in distress. The device also has a mobile communication unit. The unit is adapted to be programmable to at least two destinations to initiate communication to at least two individuals with each individual associated with one of the at least two inputs being preset in the memory. The personal locator device is adapted to not include a keypad for entering destination information to individuals other than the at least two inputs being preset in the memory so the personal locator device qualifies to be carried in an setting that prohibits mobile telephones.

In yet another aspect of the present disclosure there is provided a method of locating an individual in distress comprising selectively transmitting a distress signal to a remote entity identifying a personal locator device by an identification code that a user associated with the personal locator device is in distress. The method also provides the personal locator device with a mobile communication unit. The unit is operable to make GSM voice calls. The personal locator device is adapted to be programmable to initiate communication to only at least two individuals with each individual associated with an input being preset in a memory. The method provides that the personal locator device qualifies that the personal locator device may be permitted in an setting that prohibits mobile telephones by the personal locator device being adapted to not include a keypad for entering destination information to individuals other than the at least two inputs being preset in the memory.

In another embodiment of the present disclosure, there is provided a personal locator device that has a housing including a processor being coupled to a bus, and a memory being coupled to the bus disposed in the housing. The housing comprises a wrist watch like housing and a band connected to the wrist watch housing. A global positioning system comprises a receiver and a transmitter being coupled to the bus. The memory has an identification code and a mobile communication unit being coupled to the bus comprising a speaker and a microphone. A user interface includes at least two inputs disposed on the housing. The personal locator device also has a power source. The transmitter is adapted to be controlled by the processor to provide a distress signal to a remote entity identifying the personal locator device by the identification code that a user associated with the personal locator device is in distress.

The mobile communication unit is adapted to be programmable to at least two destinations to initiate communication to at least two individuals with each individual associated with one of the at least two inputs being preset in the memory. The at least two individuals are at least a guardian of a child wearing the watch or parent and a contracted 3^{rd} party monitoring company. The personal locator device is adapted to not include a keypad for entering destination information to individuals other than the at least two inputs being preset in the memory so the personal locator device qualifies to be carried in an setting that prohibits mobile telephones.

In yet another aspect of the present disclosure there is provided a personal locator device that has a computer device connected to a network and a navigation system for determining a real time location of the personal locator device. The computer device is adapted to transmit a distress signal to a remote entity via the network identifying the personal locator device and that a user associated with the personal locator device is in distress. The personal locator device also has an integrated mobile communication unit. The unit is adapted to be programmable to at least two destinations to initiate communication to at least two individuals via the network. Each individual is associated with one input of at least two inputs stored in a memory. The at least two individuals are at least a guardian of a child wearing the watch or parent and a contracted 3^{rd} party monitoring company. The inputs are disposed on an exterior of the personal locator device. The personal locator device also has a parental control device wherein the personal locator device is adapted to not accept destination information of individuals other than the individuals associated with the at least two inputs so the personal locator device qualifies to be carried in an setting that prohibits mobile telephones.

### BRIEF DESCRIPTION OF THE FIGURES

The foregoing and other objects, features and advantages of the invention will be apparent from the following more particular description of preferred embodiments of the invention, as illustrated in the accompanying drawings in which like reference characters refer to the same parts throughout different views. The drawings are not meant to limit the invention to particular mechanisms for carrying out the invention in practice, but rather, are illustrative of certain ways of performing the invention. Others will be readily apparent to those skilled in the art.

FIG. 1 shows a personal locator device according to the present disclosure having a mother call input button, a father call input button and an emergency distress signal input button or another button configured to call a contracted 3^{rd} party monitoring company.

FIG. 2 shows a system level diagram of the personal locator device that includes a navigation device that communicates via satellite to a network to communicate a distress signal from the personal locator device to the emergency personnel or parent operating with a computer or a contracted 3rd party monitoring company; and

FIG. 3 shows a general purpose computer operatively connected to a navigation device and a mobile communication device.

### DETAILED DESCRIPTION OF THE PREFERRED EMBODIMENTS

The present disclosure is directed to a personal locator device 10 that has an integrated mobile communication device incorporated into the device 10. The personal locator device 10 also further includes an input configuration that only permits calls to exclusive individuals and will not permit input to calls or communication to other individuals. The personal locator device 10 and mobile communication device will be allowed to be used in an educational setting, such as a school or in a hospital which does not permit mobile communication devices, such as cell phones, BLACKBERRY setting, such as a school not permit input to calls or communication to other individuals. The personal 10 and integrated mobile communication device is superior to a cellular phone as the students pose no distraction to the teachers by sending text messages to other students or making voice calls to individuals other than the exclusive individuals. Preferably, the exclusive individuals are only the child's parents, guardian, educators, school principals, nanny, protector or emergency personnel. Preferably, the personal locator device 10 has parental control functionality and does not include any keypad with numerical or alphanumeric keys.

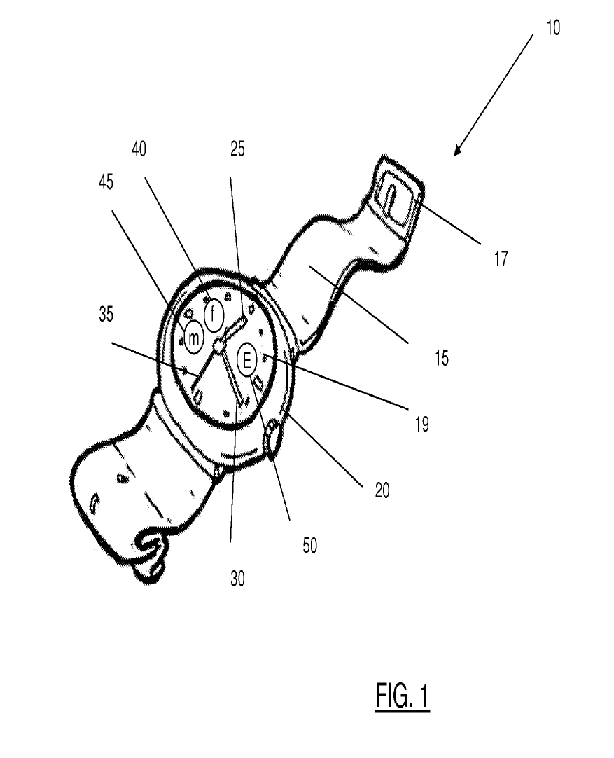

Turning to FIG. 1, there is shown a personal locator device 10. The personal locator device 10 preferably takes the form of a conventional watch having a band 15, a face 20 and a clasp 17 to fasten the band 15 securely around the wrist of the child. In yet another exemplary embodiment of the present disclosure, the personal locator device 10 may take another form, such as, for example, a “clip on device” affixed to a backpack, a book bag or clip that may be secured on the child's person, for example a leg bracelet or lanyard to wear around the neck. The face 20 of the personal locator device 10 may include a clock dial 19, and a number of watch hands, for example an hour hand 25, a minute hand 30 and a seconds hand 35. It should be appreciated that the watch face 20 may further include an analog watch device (not shown) to keep accurate time, however it should also be appreciated that the watch face 20 may further be manufactured as a digital device instead of the analog configuration shown with a liquid crystal display. Various configurations are possible and within the scope of the present disclosure.

The personal locator device 10 also includes a number of inputs, or a first input 40, a second input 45 and a third input 50 and does not include a keypad including a number of QWERTY keys or any touch screen, or any touch tone numerals for making voice calls or electronic messages. The inputs 40, 45, 50 preferably are a parental control type device that will restrict the use of the personal locator device 10 and the mobile communication device so the device 10 can qualify for uninterrupted use in an educational setting. The first input 40 of the device 10 preferably can be preset to initiate a voice call to a child's first parent, or, for example, a child's father as is designated “F”. The second input 45 of the device 10 preferably can be preset to initiate a voice call to a child's second parent, or, for example, a child's mother and is designated “M”.

It should be appreciated that these destinations form no limitations to the present disclosure and the present personal locator device 10 with integrated mobile communication device may alternatively be preset to call other individuals, such as, for example, a guardian, a nanny, a protector, adopted parents, godfather, godmother, a grandparent, an aunt, an uncle, a brother, a sister, a neighbor, a cousin, a trusted friend, lawyer, a contracted 3rd party monitoring company or any other individual associated with the care of the child or that may get in touch with an individual associated with the care of the child. The third input 50 of the device 10 preferably can be preset to initiate an emergency beacon signal to an emergency personnel, such as, for example, a child recovery service, the police, the fire department, the military, paramedics, the FBI, a marine vessel, or a search and rescue unit. Various emergency destination addresses are possible depending on the geographic location of any potential abduction and may vary and are within the scope of the present disclosure. Preferably, in one embodiment, the parents can pay a subscription fee to use the personal locator device 10 and a certain amount per month for child monitoring.

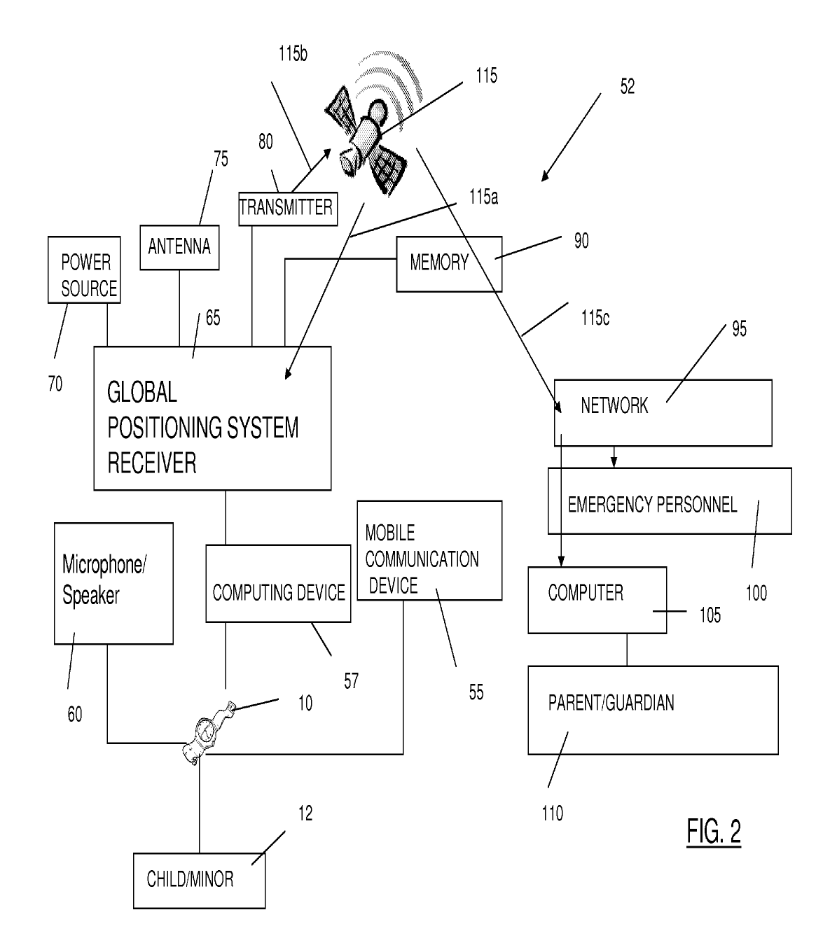

Turning now to FIG. 2, there is shown a system level diagram generally shown as reference numeral 52. The system 52 preferably includes a navigation system, which generally is represented as a Global Positioning System having a GPS receiver 65 that is incorporated into the personal locator device 10 and that receives downlink timing signals 115a from a Global Positioning System satellite 115. “GPS” is a shorthand name for Global Positioning System, a system of satellites 115, computers, and receivers that is able to determine the latitude and longitude of a receiver 65 on land and sea by calculating the time difference for signals 115a from different satellites 115 to reach the receiver 65. The global positioning system is well known in the art.

Developed and operated by the U.S. Defense Department, the Global Positioning System (GPS) is a radio-navigation system consisting of a 24-satellite constellation. Using precise location and timing signals emitted by these satellites, GPS permits land, sea and airborne users to determine their three-dimensional position, velocity and time twenty four hours a day, in all weather. The instant GPS system is operable to obtain positional information anywhere in the world, providing location with a precision and accuracy far better than any other radio navigation system. Preferably, using the signals 115a received by the GPS receiver 65, the precise and accurate location in longitude and latitude of the personal locator device 10 may be determined. The GPS receiver 65 preferably includes an antenna 75, a wireless signal transmitter 80, an identification memory 90, and signal processing chipset (not shown) that are all coupled to a power source 70. The chipset (not shown) preferably includes a unique code that identifies the specific receiver 65. In one embodiment, the device 10 uses the global positioning system (GPS) chip ublox-6 available from u-blox AG, Thalwil, Switzerland. In this embodiment, when the guardian 110 is indoors, the device 10 switches to agps/cellular triangulation. The device 10 may be configured by default, to switch to agps/cellular triangulation when indoors and when the GPS receiver 65 in the device 10 stops receiving the downlink timing signals 115a from the Global Positioning System satellite 115 signal.

Alternatively, the system 52 preferably may be manufactured using other navigation devices 65, such as, for example, EGNOS, Galileo, or Euridis satellite navigation. For example, the system 52 may alternatively infer the position of the personal locator device 10 using a mobile telephone network. System 52 may obtain an intensity reading and a direction of a radiofrequency signal emitted from a mobile communication device 55 to a mobile communication tower (not shown) as is known in the art. Using the intensity and direction of the signal with the known location of the mobile communication tower in a software program, the system 52 can infer the location of the personal locator device 10 and the child 12. Still in another alternative embodiment, the system 52 may include an electronic compass to determine a location of the personal locator device 10 and the child 12. Further and less preferably, the personal locator device 10 may alternatively detect positional information as the child 12 passes around certain preset land beacons.

Preferably, the system 52 includes an integrated mobile communication device 55 and a computing device 57 disposed in the housing of the watch face 20. The personal locator device 10 also includes a speaker and a microphone generally shown as reference numeral 60. The mobile communication device 55 may include any GSM, CDMA, TDMA, FDMA mobile phone that can be operable with a SIM card and operable using known mobile communication providers. The mobile communication device 55 is operable with antenna 75 under any of the frequency ranges of 850 MHz, 900 MHz, 1800 MHz, and 1900 MHz depending on the specific country the locator device 10 is used. In addition to the power source 70, which is preferably a lithium ion battery, the mobile communication device 55 of the personal locator device 10 may require a small microchip, called a Subscriber Identity Module or SIM Card, to function. The SIM Card is usually placed underneath the battery 70 in the rear of the personal locator device 10, and (when properly activated) stores the mobile communication device's 55 configuration data, and information about the mobile communication device 55 itself, such as which calling plan the subscriber is using (i.e., Verizon such as which calling plan the subscriber is usingnication device Car10 works world wide on the GSM network, and comprises subscriber identity modules configured to work internationally. When the subscriber removes the SIM Card, it can be re-inserted into another phone that is configured to accept the SIM card. Preferably, the mobile communication device 55 requires a printed circuit board (not shown) for engaging with other components of the device and may be operable to engage with electronics for VOICE OVER IP (VOIP), Wi-Fi, infrared, and Worldwide Interoperability Microwave Access (WiMAX) for sending voice and data. Preferably, the mobile communication device 55 further includes a radiofrequency module, a transmitter and receiver or transceiver, an RF surface wave acoustic filter, and an amplifier. In an instance, if the power source 70 is low on power, the device 10 sends a ‘low battery’ alert to both the cell phone of the guardian 110 and the system 52. For example, alerts are sent to the guardian via one or more of e-mail, SMS text, and the tracking platform also receives the alerts. The mobile communication device 55 may have various configurations that are within the scope of the present disclosure.

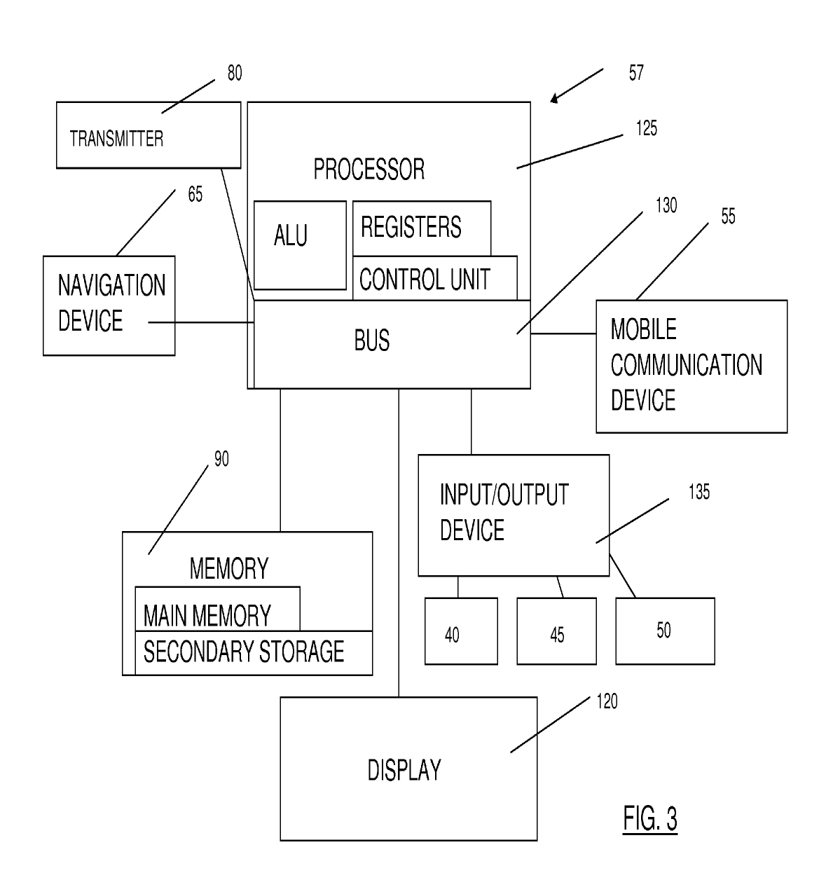

Preferably, the computer device 57 continuously receives downlink signals 115a from the satellite 115 via the GPS receiver 65 and using this information calculates a three dimensional position of the personal locator device 10 and stores the position in memory 90 (FIG. 3). When in distress, the child 12 may activate at least one of the inputs 40, 45, 50 on the dial 19 of the watch face 20. In response, the computing device 57 will communicate a distress signal 115b via the transmitter 80 to the satellite 115 or other destination. It should be appreciated that in another embodiment, the distress signal 115b may be routed via an electronic message that is communicated via the Internet or via a mobile telephone communication network and does not necessarily have to be communicated to the satellite 115. The distress signal 115b preferably includes a three dimensional or two dimensional position information including a latitude and longitude of the personal locator device 10. The distress signal 115c is received by the satellite 115 and then is routed to a network 95. Distress signal 115c can be in the form of an internationally recognized means for obtaining help and may take the form of radio signals from a distance. In yet another exemplary embodiment of the present disclosure, the device 10 comprises a geo fence, where alerts are sent to the guardian when the device is within the geo fence perimeter, outside the geo fence perimeter for a given time or schedule. The geo fence feature provides the guardian 110 with an option to set parameters for the device 10 worn by the child 12. One of the parameters may comprise allowing the guardian 110 to put a 100 feet buffer around a home or school of the child 12. If the child 12 wearing the device 10 moves outside the 100 feet buffer, an alert is sent to the cell phone of the guardian 110 via short text messages (SMS) and as general packet radio service (GPRS) data to the system 52. In yet another exemplary embodiment of the present disclosure, the device 10 comprises a speed alert incorporated in the geo fence and works both within and outside the geo fence perimeter. If the guardian 110 does not want the child 12 to be present near a water body such as a water pond, an alert is sent to the cell phone of the guardian 110 via short text messages (SMS) and as general packet radio service (GPRS) data to the system 52. It is estimated that almost 50 percent of kids affected by autism have a tendency to wander aimlessly. In such a case, a child 12 affected by autism might be drawn towards water bodies and a high probability exists that the child 12 might slip and drown in the water body. With the speed alert feature of this embodiment the guardian 110 can create a fence 1000 feet away with reference to the position and proximity of the child 12 to the pond. The guardian 110 will be alerted if the child 12 enters the fence. In addition, the device 10 is tamper proof and is good for law enforcement during in-house arrest. Exemplarily, the device has a compact dimension with a width of 37 mm, length of 37 mm and thickness of 17 mm.

A distress signal (SOS/Panic) 115c preferably indicates that a child 12 is threatened by grave and imminent danger and requests immediate assistance. Preferably, the distress signal 115c communicates at least two functions or an alert or notification of a distress in progress and the exact position or location (or localization or pinpointing) of the child 12 in distress. In yet another embodiment, the personal locator device 10 may use the COSPAS-SARSAT 406 MHz radio frequency distress signal 115c directly to the emergency personnel 100. COSPAS-SARSAT 406 MHz signal is generally used by hikers, backpackers, trekkers, mountaineers and other ground-based remote adventure seekers and personnel working in isolated backcountry areas using a small, portable personal locator beacon. In yet another exemplary embodiment of the present disclosure, a G force sensor alert is provided. The G force sensor is configured to determine a rate of acceleration of the device 10. Sensitivity of the G force sensor can be set from a range of 1 to 8. Depending on the setting, the G force sensor is configured to send an alert to the system 52. Consider an example where a range of 2 is set for a 120 year old person. If the person falls, the G force sensor will sense the fall and send an alert to the system 52. The G force sensor, although originally defined for children, is now configurable for use by elder stay at home alone people diagnosed and those with diseases like Alzheimer's. Other applications of G force sensor include law enforcement, bullet proof vests, in house arrest, autistic patients etc. In yet another alternative embodiment, the distress signal 115c or 115b can be a signal associated with a civilian or military aircraft emergency frequency for voice distress using 121.5 MHz or 243 MHz.

Network 95 may be any communication network in the art, and may include a network of telecommunications links and nodes arranged so that a message or the signal 115c may be passed from one part of the network to another over multiple links and through various nodes. In yet another exemplary embodiment of the present disclosure, the device 10 comprises a band alert (not shown) feature. If the band 15 of the device 10 is cut or removed or opened from the child's 12 hand, the band alert feature sends an alert both by short text messages (SMS) to the guardian's 110 cell phone (not shown) and a general packet radio service (GPRS) signal to the system 52. Furthermore, each guardian 110 may have their own platform (not shown) to track the device 10 sending the band alert. In one embodiment, the band alert feature is configured to send short text messages (SMS) comprising information regarding the location of the device 10. The short text messages (SMS) can be written in data script for eliminating/minimizing the cost of short text messages (SMS). Using the short text messages (SMS), the guardian 110 obtains the latitude and longitude as well as the position of the device 10 in any particular region via a mapping service such as Google Maps service available from Google Inc. of Mountain View, Calif., United States of America. In one embodiment, the guardian 110 can use the platform (not shown) to obtain historical data of day by day activity for up to a few months.

Telecommunications network links (including their endpoints or “nodes”) may in turn be built out of hierarchical transmission systems. Examples of telecommunications networks 95 may be any wireless or wired network, a computer network, the Internet, a public switched telephone network, or an aeronautical ACARS network. Network 95 via the links may communicate the distress signal 115c to emergency personnel 100 with the longitude and latitude positional information of the child's 12 location so the emergency personnel 100 can be dispatched and recover the child 12 along with medical care and medical personnel, if needed. Emergency personnel 100 may be the parents or a guardian, the police, fire department, paramedics, the military, a private investigator, a recovery individual or team, or 3rd party monitoring company or any other individual known in the art.

Alternatively, network 95 via the links may communicate the distress signal 115c to a computer device 105 or a mobile communication device 105, such as, a PDA. Network 95 can communicate the position of the child 12. Network 95 preferably receives data associated with the longitude and latitude information of the child's 12 location. In this manner, a parent 110 or guardian 110 can track the child 12 using a software application stored on the memory associated with a computer 105. The software application stored on the computer device 105 may, for example, overlap the child's position over a geographic map displayed on a display. Parent or guardian 110 may then track the child 12 in real time or in an emergency situation or the parent or guardian 110 may contact the emergency personnel 100 to recover the child 12. It is envisioned that in one embodiment, the parent or guardian 110 may track the child 12 in a non-emergency situation using any mobile device, PDA or computer device 105. The parent 110 or guardian 110 can track the child over the internet using a web browser on a web based platform.

Turning now to FIG. 3, there is shown a general purpose computer to be used with certain aspects of the personal locator device 10 and method of the present disclosure. The present disclosure may be implemented on a computer system 57. The computer system 57 preferably includes the generic components of most general purpose computers.

The computer system 57 comprises an interconnection mechanism, such as a bus 130, or circuitry which couples to an input device 135, such as a keyboard. Keyboard 135 is optional and is used only to initially program the computer system 57 with the parent or guardian's phone numbers, or email addresses. Keyboard 135 can be operatively connected to the personal locator device 10 and then removed so the child 12 cannot manipulate and make voice calls to other individuals other than those which are preset on the inputs 40, 45 and so the device 10 is used as intended to activate the emergency distress signal 50. It is envisioned that the personal locator device 10 may have a specialized unique computer port (not shown). Port is specialized so an input device 135 may be coupled to the personal locator device 10 for installation and initial programming of the personal locator device 10 and so other USB type keyboard cannot be connected to the personal locator device 10. The system also has a processor 125 (such as a microprocessor having an arithmetic logic unit, a register and a control unit). The computer 57 also includes a storage device or memory 90 (such as a computer disk for a main memory and secondary storage) and an optional output device such as a monitor or screen 135. Alternatively, the personal locator device 10 may have no screen 135 to disguise the personal locator device 10 so that in a kidnapping or abduction situation, the personal locator device 10 will not be removed by the abductor or kidnapper. Moreover, distress signal may be silent so the kidnapped or abductor will be unaware of the call for help.

As mentioned above, the personal locator device 10 is programmable. A guardian of a child wearing the personal locator device 10, parent or a contracted 3^{rd} party monitoring company can disable the band alert feature for removing the band 15 of the personal locator device 10. The band 15 can be separated from the personal locator device 10 and the personal locator device 10 can be used as a pendant or inserted in a pocket of the cloth of the wearer. The personal locator device 10 is also compact and can also be concealed from view. The personal locator device 10 is waterproof and is constructed to remain functional even when submerged in water for up to a certain depth.

The computer 57 also has a mobile communication device 55 that may also act as a network connection for connecting to the Internet. Various embodiments of the invention will be described in conjunction with the components of computer systems. A typical example of a computer system is an IBM® Personal Computer, an APPLE® MAC® computer, MICROSOFT WINDOWS MOBILE® computer, or a compatible computer. Preferably, when the user depresses a button or touch screen prompt or otherwise activates an input 50, the processor 125 access a current three dimensional location of the personal locator device 10 as received from the navigation system 65. Processor 125 then sends a control signal to the transmitter 80 to deliver the emergency beacon and to transmit the precise three dimensional location of the personal locator device 10 in a signal 115b (FIG. 2).

Signal 115b is preferably a digital signal and may further comprise data with information to identify the personal locator device 10. Signal 115b is communicated in a high powered beam to the satellite 115 or via a communication network 95 (the Internet) to obtain the emergency personnel 100 and to indicate a kidnapping, abduction or that the user is lost. Additionally, when the user depresses a button or touch screen prompt or otherwise activates the input 40 or 45, the processor 125 access a stored address in memory 90. The address is at least one of a phone number, an e-mail address, a SKYPEally, when the user depresses a button other communication address of at least one the child's mother or the child's father or other guardian as previously discussed of the personal locator device 10. Processor 125 then controls the mobile communication device 55 to call, send a text message, or e-mail, the child's parent. Using the microphone and speaker generally shown as reference numeral 60, the child 12 can communicate with the parents, and specifically not communicate or send or receive text messages and e-mails with friends or take photos.

In yet an alternative embodiment of the present disclosure, the personal locator device 10 may be further manufactured with a keypad that is a QWERTY keypad, or a touchtone keypad that is rendered inoperable using a parental control device by a parent so the child 12 can only communicate with the child's mother or the child's father or depress the emergency button. In yet an alternative embodiment of the present disclosure, the personal locator device 10 may be manufactured without the navigation device 65 and may only have the mobile communication device 55.

In yet an alternative embodiment of the present disclosure, the personal locator device 10 may be further manufactured with a diagnostic device to measure a parameter of the wearer, such as an amount of glucose in the blood of the wearer or other parameter (i.e., diabetes information, heart rate, pulse, etc). In a further embodiment, the device 10 is a quad band phone adapted for 850 and 1900 MHz signals used in the North America and South America, and 900 and 1800 used in the rest of the world (GSM Network) that can make outgoing calls only with a navigation device and may optionally have a medical diagnostic device.

In another embodiment, the personal locator device 10 comprises a GPS receiver 65 a GSM module, and a G force sensor module (accelerometer). The personal locator device 10 provides three modes of tracking, namely active tracking, mobile Personal Emergency Response Service (mPERS) tracking and SOS/Panic tracking. A platform (not shown) is also provided to report and remotely monitor the personal locator device 10.

The personal locator device 10 is programmed in 3 ways. Active Tracking, mPERS/Passive Tracking and SOS/Panic Tracking. Each programming mode makes the personal locator device 10 act and responds differently. In each programming mode, personal locator device 10 reports only certain features and functionality and draws a different amount of power from the battery. Doing this increases the battery life of the personal locator device 10 and also enables the personal locator device to be marketed and promoted to different vertical market segments.

In active tracking mode, all aspects of the personal locator device 10 are always on and in use, and tracking happens in real-time. This mode is suitable for persons with cognitive disorders. Therefore, in active mode, the GSM module, GPS receiver 65 and the G force sensor module are always on, thus enabling all features and functionality of the device and the platform (not shown) to record and monitor the personal locator device 10. In this mode, the personal locator device 10 is expected to have a battery life of at least 24 hours and up to 30 hours. The G force sensor module determines a rate of acceleration of the personal locator device 10 (to sense a fall) and sends an alert to the platform (not shown). Sensitivity of the G force sensor module is remotely programmable from the platform (not shown). The sensitivity is adjustable over a scale of 1-5 or 1-8. Geo fence (in and out) may also be timed and scheduled to detect geo fence activity. Geo fence activity may be tracked and reported by the platform (not shown). Geo fence is a virtual fence defined by a bounded perimeter defining a location. Geo fence violation occurs when the GPS receiver 65 reports a location which is outside the bounded perimeter. Perimeter of the geo fence is defined using the platform (not shown). The personal locator device 10 is on an active tracking mode by default, and the platform (not shown) can be used to configure the personal locator device 10 to one of mPERS (mobile Personal Emergency Response Service) tracking and SOS/Panic tracking mode.

The personal locator device 10 enters the active mode automatically during an alert event and stays in the active mode until cleared from the platform (not shown). Once cleared from the platform, the personal device locator exits the active mode and reverts back to the original settings.

In addition, the active tracking mode is configured to send additional alerts to a person monitoring the personal locator device 10 via the platform (not shown). The additional alerts comprise speed alert, low-battery alert and a stop report.

As explained above, in active tracking mode, all aspects of the personal locator device 10 are always on and in use, and tracking happens in real-time. Both the GPS receiver 65 and the GSM module are on and all features and functionality are reported and/or monitored. The features and functionally include but are not limited to: the GSM module calling to a programmed number, SOS button alert, G-Sensor Alert (for slip and falls), Geo-Fence Alerts (on exit, entrance, by time, schedule, and off route), Speed Alert, Stop Log Reports, Trip Log Reports, any event that accrues can be reported as an alert accessed in a data base and exported to excel or crystal report.

In active tracking, the personal locator device 10 has a memory that stores information of current and past real-time data that is reported by time or distance whichever comes first. For example, the personal locator device 10 comprises a default setting to report information of real-time data every 30 minutes or 1 mile of distance travelled whichever comes first. If the personal locator device 10 sits in the same spot for 24 hours or for any other given time, the device personal locator device 10 uploads the real-time data every 30 minutes. On the other hand, if the personal locator device 10 is traveling in a car, the personal locator device 10 reports every mile of the distance travelled, thereby automatically reporting information of real-time data based on time or distance whichever comes first. In one embodiment, the personal locator device 10 is configured to report its location every minute and every 1 foot or as per the requirements of a user. The frequency of reporting can be reduced to save on battery consumption. Reducing the frequency of reporting of information of real-time data also lowers data usage reducing the GSM carrier (service provider) fee and/or subscription fee. Presence of a memory in the personal locator device 10 enables a person monitoring the personal locator device 10 to override the setting of the personal locator device 10 to instantly report its position in real-time in the case of an event. Therefore, in case of emergency, there is no need to wait till the lapse of a preset time period or wait for the wearer of the personal locator device 10 to travel a predefined distance.

The battery life of the personal locator device 10 in active tracking mode is configured to last for about 30 hours or more based on activity/use.

The mPERS tracking mode is specifically designed for elderly stay at home individuals. The mPERS tracking mode is the GPS/GSM cellular version of “Help I have fallen and can't get up!”. In mPERS tracking mode, the GPS receiver 65 is in sleep mode since these individuals do not need to be actively tracked by GPS in real-time. The personal locator device 10 is actively tracked only if the wearer of the personal locator device 10 pushes a SOS/Panic button on the personal locator device 10. On pushing the SOS/Panic button on the personal locator device 10 for example, in an emergency, the personal locator device 10 enters the active tracking mode and a real-time tracking of the personal locator device 10 is possible, enabling identification of the location of the personal locater device 10. Pushing the SOS/Panic button on the personal locater device 10 also calls a predefined number programmed into the personal locater device 10. The mPERS tracking mode saves battery life of the personal locater device 10 since the GPS receiver 65 is activated based on the requirement. The personal locater device 10 is expected to have a battery life of up to 4 days in the mPERS tracking mode. If a person is reported lost, the monitoring the platform (not shown) may remotely turn on the GPS receiver 65 on the personal locator device 10 to locate the person wearing the personal locator device 10. The GSM module is always kept on such that the personal locator device 10 can receive inbound calls and also receive commands from the platform (not shown).

As explained in the above paragraph, in the mPERS tracking mode, the GPS receiver 65 is in sleep mode and the G force sensor module and GSM module are always on. The personal locator device 10 automatically enters the active tracking mode from the mPERS tracking mode during an alert event or when the SOS/Panic button is pressed on the personal locator device 10, and stays in the active tracking mode until cleared from the platform (not shown). Once cleared from the platform (not shown), the personal locator device 10 exits the active tracking mode and reverts back to the original settings. In mPERS mode, the G force sensor is always on and the personal locator device 10 is configured to raise an alert event on detection of an abnormal output or on detection of a sudden change in the output of the G force sensor. The sudden change in output or the abnormal output is configured to raise an alert that a person wearing the personal locator device 10 has fallen down. The falling down of the person will register an abrupt change in G-Sensor readings.

In addition to other alerts, in the mPERS mode the personal locator device raises an alert when the battery on the personal locator device goes low.

The mPERS tracking mode enables a person to track the personal locator device 10 in a passive way. In mPERS passive tracking mode, the GPS receiver 65 is in sleep mode. Passive tracking can be utilized by mPERS customers who, for privacy purposes, do not like to be tracked in real-time and have their data stored. This is similar to the version of the common RF (Radio Frequency) device products on the market for example, “ife Al′ve fallen and I can't get up!”® of Life Alert Emergency Response, Inc., headquartered in Encino, Calif. The mPERS passive tracking mode increases battery life by up to 4 days verses up to 30 hours in other modes. Since mPERS tracking mode does not track by time or distance, it does not use large amounts of battery life and GSM Carrier data.

The features of mPERS tracking mode are more limited then Active Tracking mode. In mPERS tracking mode, the personal locator device 10 monitors, reports, and send alerts only on activation of SOS/Panic button, during G-Sensor slip or falls, and when the battery goes low. If the user pushes the SOS button for enabling location of the personal locator device 10, the personal locator device 10 goes into active tracking until the responder clears\handles the emergency, after which the personal locator device 10 reverts back to its default setting. Since the GSM module can receive inbound calls from anywhere and from the monitoring company, the wearer of the personal locator device 10 can be contacted by a phone call and reminded to charge the device

The SOS/Panic Tracking Mode is designed for corporate and personal security. For privacy purpose, the SOS/Panic tracking mode does not track the individual in real-time and record the movements of the individual. In SOS/Panic tracking mode, both the GSM module and the GPS receiver 65 are in sleep mode. In SOS/Panic tracking mode, active tracking of the personal locator device 10 is performed only when the individual pushes the SOS/Panic button on the personal locator device 10 or when the personal locator device 10 detects abnormal or sudden changes in G force sensor readings. Once the personal locator device 10 enters into active tracking mode, the personal locator device 10 turns on all features as described in the active tracking mode above. The personal locator device 10 will not receive inbound calls since it is in sleep mode. However, if the SOS/Panic button is pushed, the personal locator device 10 calls the number programmed into the personal locator device 10 and simultaneously receives inbound calls. Since both the GSM module and the GPS receiver 65 are in sleep mode, this mode enables the battery to last for at least 5 days and up to 6 days.

In this mode an alert is raised when the SOS/Panic button is pressed on the personal locator device 10 or when the personal locator device 10 detects abnormal or sudden changes in G force sensor readings. The personal locator device 10 enters and remains in the active tracking mode until the personal locator device 10 is reconfigured using the platform (not shown).

In addition to other alerts in SOS/Panic tracking mode, the personal locator device 10 raises an alert when the battery on the personal locator device goes low.

In the SOS/Panic tracking mode, both the GPS receiver 65 and GSM module of the personal locator device 10 are in sleep mode to meet the needs of corporations, government, private and fortune 100 to 1000 security business needs. Since the GPS receiver 65 and GSM module are in sleep mode, the SOS/Panic tracking mode saves battery life and data charges, enabling the service to be offered at a lower cost to the consumer. In SOS/Panic tracking mode the battery can last up to 7 days based on activity/use. In SOS/Panic tracking mode, tacking data is not stored. Any information stored from the personal locator device 10 is passive tracking data which is stored only on occurrence of an activity. The only features monitored in SOS/Panic tracking mode are passive tracking data, SOS/Panic button push response, G-Sensor for slip and falls or gun shots, and battery status. As explained above passive tracking can be utilized for privacy purposes. The personal locator device 10 will be unable to receive calls since the GSM module is in sleep mode. The personal locator device 10 cannot be tracked because the GPS receiver 65 is in sleep mode. The personal locator device 10 works in active tracking mode only when the wearer pushes the SOS/Panic button, and stays in the active tracking mode until the responder clears or handles the emergency.

Generally, in operation, the computer system operable is controlled by an operating system. Typical examples of operating systems are LINUX, MS-DOS, Windows 95, Windows XP, Windows 7, MICROSOFT WINDOWS MOBILE from Microsoft Corporation, or Solaris and SunOS from Sun Microsystems, Inc., or the Apple OSX from Apple Corporation. As the computer system operates, input such as input search data, database record data, programs and commands, received from users or other processing systems, are stored on storage device. Certain commands cause the processor to retrieve and execute the stored programs. The programs executing on the processor may obtain more data from the same or a different input device, such as a network connection. The programs may also access data in a database for example, and commands and other input data may cause the processor to index, search and perform other operations on the database in relation to other input data. Data may be generated which is sent to the output device for display to the user or for transmission to another computer system or device. Commands can be sent to the system 52 to easily program one or more of the settings disclosed in the above disclosure. Typical examples of the computer system are personal computers and workstations, hand-held computers, dedicated computers designed for a specific purpose, and large main frame computers suited for use many users. The present invention is not limited to being implemented on any specific type of computer system or data processing device.

It is noted that the present invention may also be implemented in hardware or circuitry which embodies the logic and processing disclosed herein, or alternatively, the present invention may be implemented in software in the form of a computer program stored on a computer readable medium such as a storage device. In the later case, the present invention in the form of computer program logic and executable instructions is read and executed by the processor and instructs the computer system to perform the functionality disclosed as the invention herein. If the present invention is embodied as a computer program, the computer program logic is not limited to being implemented in any specific programming language. For example, commonly used programming languages such as C, C++, JAVA as well as others may be used to implement the logic and functionality of the present invention. Furthermore, the subject matter of the present invention is not limited to currently existing computer processing devices or programming languages, but rather, is meant to be able to be implemented in many different types of environments in both hardware and software.

Furthermore, combinations of embodiments of the invention may be divided into specific functions and implemented on different individual computer processing devices and systems which may be interconnected to communicate and interact with each other. Dividing up the functionality of the invention between several different computers is meant to be covered within the scope of the invention.

While this invention has been particularly shown and described with references to a preferred embodiment thereof, it will be understood by those skilled in the art that is made therein without departing from the spirit and scope of the invention as defined by the following claims.

1. A method of locating an individual in distress comprising:
selectively transmitting a distress signal to a remote entity identifying a personal locator device by an identification code that a user associated with the personal locator device is in distress; and
providing the personal locator device with a mobile communication unit, which is operable to make voice calls, the personal locator device being adapted to be programmable to initiate communication to only at least two individuals with each individual associated with an input being stored in a memory; and
qualifying that the personal locator device is permitted in an setting that prohibits mobile telephones, the personal locator device being adapted to not include a keypad for entering destination information to individuals other than the at least two individuals associated with the inputs being preset in the memory.

2. The method of claim 1, further comprising transmitting the distress signal to a satellite identifying the personal locator device by the identification code.

3. The method of claim 2, further comprising transmitting the distress signal from the satellite to a second entity being a rescuer.

4. The method of claim 1, further comprising storing a family member's phone number or electronic address as at least one input.

5. The method of claim 1, further comprising storing a child's mother's and a child's father's phone numbers or electronic addresses as the at least two inputs.

6. A personal locator device comprising:
a housing including a processor being coupled to a bus, a memory being coupled to the bus disposed in the housing;
the housing comprising a wrist watch housing and a band being connected to the wrist watch housing;
a global positioning system comprising a receiver and a transmitter being coupled to the bus;
the memory comprising an identification code; a mobile communication unit being coupled to the bus comprising a speaker and a microphone;
a user interface comprising at least two inputs disposed on the housing; a power source; and
the transmitter being adapted to be controlled by the processor to provide a distress signal to a remote entity identifying the personal locator device by the identification code that a user associated with the personal locator device is in distress; and
the mobile communication unit being adapted to be programmable to initiate communication to at least two individuals with each individual associated with one of the at least two inputs being preset in the memory; and
the personal locator device being adapted to not include a keypad for entering destination information to individuals other than the at least two inputs being preset in the memory so the personal locator device qualifies to be carried in an setting that prohibits mobile telephones.

7. The personal locator device of claim 6, wherein, the at least two individuals being at least a guardian of a child wearing the watch.

8. A method of locating individuals in distress comprising:
providing a personal locator device comprising a global positioning system (GPS) receiver, a global system for mobile (GSM) module, a g force sensor module and a panic button disposed on an exterior part of a housing enclosing the personal locator device, said GPS receiver, said GSM module, said g force sensor module and said panic button communicatively coupled to at least one processor;
communicatively coupling said personal locator device with a platform;
deactivating said GPS receiver and said GSM module;
creating an alert event based on activation of said panic button, said alert event comprising:
reactivating said GSM module and GPS receiver;
sending an alert to at least one individual via said platform;
initiating communication to said at least one individual using a predefined electronic address of said individual; and
providing location information to said platform by said GPS receiver, wherein said at least one individual is provided with said location information of said personal locator device.

9. A method of locating individuals in distress comprising:
providing a personal locator device comprising a global positioning system (GPS) receiver, a global system for mobile (GSM) module, a g force sensor module and a panic button disposed on an exterior part of a housing enclosing the personal locator device, said GPS receiver, said GSM module, said g force sensor module and panic button communicatively coupled to at least one processor:
communicatively coupling said personal locator device with a platform;
deactivating said GPS receiver;
creating an alert event on one of:
detecting one of an abnormal and a sudden change in said g force sensor readings;
detecting an activation of said panic button;
wherein said alert event comprises:
reactivating said GPS receiver;
sending an alert to at least one individual via said platform;
initiating communication to said at least one individual using a predefined electronic address of said individual; and
providing location information to said platform by said GPS receiver, wherein said at least one individual is provided with said location information of said personal locator device.

10. A method of locating individuals in distress comprising:
providing a personal locator device comprising a global positioning system (GPS) receiver, a global system for mobile (GSM) module, a g force sensor module and a panic button disposed on an exterior part of a housing enclosing the personal locator device, said GPS receiver, said GSM module, said g force sensor module and panic button communicatively coupled to at least one processor;
communicatively coupling said personal locator device with a platform;
creating an alert event on one of:
detecting the location of said personal locator device based on location information provided by said GPS receiver, wherein said detected location is outside a predefined bounded perimeter;
detecting one of an abnormal and a sudden change in said g force sensor readings;
detecting an activation of said panic button;
wherein said alert event comprises:
sending an alert to at least one individual via said platform;
initiating communication to said at least one individual using a predefined electronic address of said individual;
providing location information to said platform by said GPS receiver, wherein said at least one individual is provided with said location information of said personal locator device.
